(19) United States
(12) Patent Application Publication
(10) Pub. No.: US 2007/0058797 A1
(43) Pub. Date: Mar. 15, 2007

(54) Information processing apparatus and telephone exchange apparatus

(75) Inventor: Takeo Watanabe, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/474,960

(22) Filed: Jun. 27, 2006

(30) Foreign Application Priority Data
Jun. 27, 2005 (JP) 2005-186874

(51) Int. Cl. H04M 7/00

(52) U.S. Cl. 379/219

(57) ABSTRACT

According to one embodiment, a telephone exchange apparatus includes a recorder which records processing record information in relation to a processing history of the communication information on a first recording medium, a connector which connects a second recording medium differing from the first recording medium, a detector which detects the fact that a recorded information quantity in the first recording medium has reached a reference value, and a controller which transfers and records the processing record information in the first recording medium to and on the second recording medium, when the fact that the recorded information quantity in the first recording medium has reached the reference value.

### CROSS-REFERENCE TO RELATED APPLICATIONS

This application is based upon and claims the benefit of priority from Japanese Patent Application No. 2005-186874, filed Jun. 27, 2005, the entire contents of which are incorporated herein by reference.

### BACKGROUND

1. Field

One embodiment of the invention relates to an information processing apparatus for processing communication information and a telephone exchange apparatus for executing exchange processing among a plurality of telephone terminals.

2. Description of the Related Art

The telephone exchange apparatus detects an internal or external abnormality encountered in processing to record it as an error/alarm log. When call processing/maintenance of software are operated, the exchange apparatus can record an exchanged message and its content. Log information is stored in an inner memory or an external storage medium of the exchange apparatus. The format of the log is formed as one to which a time stamp is added, and the content of the log is readable by a manual, etc. The log is stored for a time period with a length of some extent.

However, if a stored quality exceeds the storage capacity of the inner memory or exceeds the set upper limit value thereof, the inner memory deletes fails sequentially from those containing data with older record times and results in an overwriting state. Therefore, in the case of an occurrence of a problem in a telephone exchange apparatus with heavy traffic, a situation, in which log data at the time of the occurrence of the problem has not been left, results in the inner memory. Consequently, if the problem does not occur again, such an exchange apparatus is brought into a situation difficult to find the cause of the problem.

In the present circumstances, we have to monitor the telephone exchange apparatus which the problem is cased therein and have to acquire data voluntarily by using a simple network management protocol (SNMP) by means of a maintenance server.

A method is proposed, (for instance, Japanese Patent application KOKAI Publication No. 2002-63048), wherein the method acquires log data to be recorded in an inner memory of a telephone exchange apparatus through remote control from a monitoring apparatus on a communication network when the exchange apparatus is connected to a communication network.

However, according to the aforementioned method, it is impossible to acquire the log data to be recorded in the inner memory by accessing to the exchange apparatus on the network without having to station a maintenance personnel or an operator at the monitoring apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a telephone exchange system regarding a first embodiment of the present invention;

FIG. 2 is an exemplary block diagram showing a functional configuration of a file transfer control unit shown in FIG. 1;

FIG. 3 is an exemplary flowchart showing a transfer control procedure of log data by the file transfer control unit in the first embodiment; and

FIG. 4 is an exemplary block diagram showing a telephone exchange system regarding a second embodiment of the present invention.

### DETAILED DESCRIPTION

Various embodiments according to the invention will be described hereinafter with reference to the accompanying drawings. In general, according to one embodiment of the invention, a telephone exchange apparatus executing exchange processing among a plurality of telephone terminals, comprising: a recorder which records processing record information in relation to a processing history of the communication information on a first recording medium; a connector which connects a second recording medium differing from the first recording medium; a detector which detects the fact that a recorded information quantity in the first recording medium has reached a reference value; and a controller which transfers and records the processing record information in the first recording medium to and on the second recording medium, when the fact that the recorded information quantity in the first recording medium has reached the reference value.

(First Embodiment)

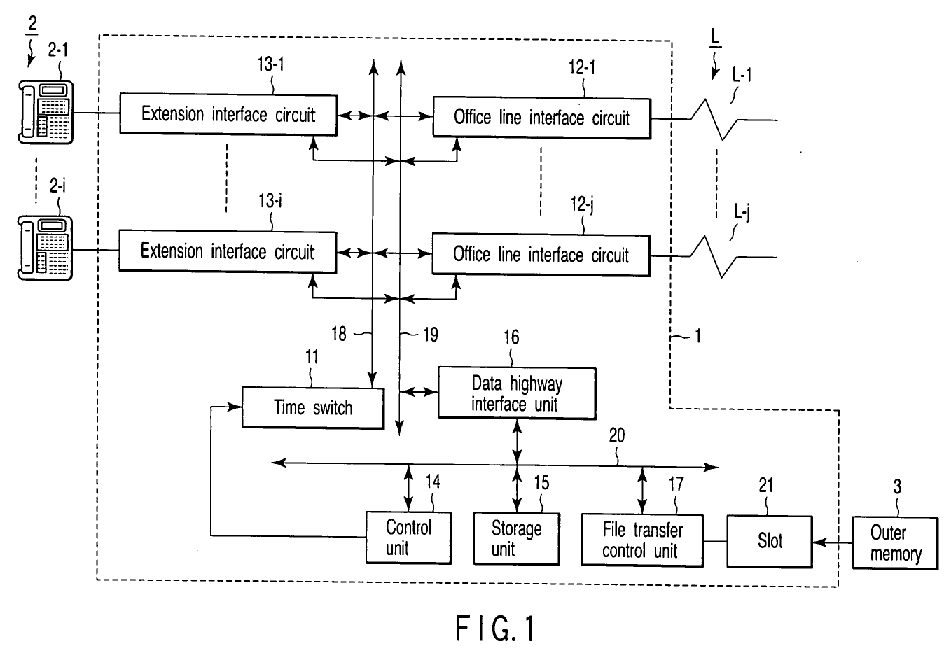

FIG. 1 is the exemplary block diagram showing the configuration of the telephone exchange system regarding the first embodiment of the present invention.

The telephone exchange system, as shown in FIG. 1, is configured by connecting a plurality of (i sets at a maximum) extension terminals 2 (2-1 to 2-i) to a telephone exchange apparatus 1 arbitrarily. Analog telephone sets or digital button telephone sets are used as to the extension terminals 2.

The exchange apparatus 1 further includes a time switch 11, a plurality of (j sets) office line interface circuits 12 (12-1 to 12-j), a plurality of (i sets) of extension interface circuits 13 (13-1 to 13-i), a control unit 14, a storage unit 15, a data highway interface unit 16 and a file transfer control unit 17. The time switch 11, the office line interface circuit 12 and the extension interface circuit 13 are connected with one another via a PCM highway 18.

The office line interface circuit 12, the extension interface circuit 13 and the data highway interface unit 16 are connected with one another via a data highway 19. Furthermore, the control unit 14, the storage unit 15, the data highway interface unit 16 and the file transfer control unit 17 are connected with one another via a CPU buss 20. The time switch 11 is directly connected to the control unit 14.

The time switch 11 replaces time slots on the PCM highway 18 on the basis of the control unit 14 then exchanges and connects the office line interface circuit 12 and the extension interface circuit 13 arbitrarily with each other.

The office line interface circuit 12 connects office lines L (L-1 to L-i) such as a public line and a private line thereto if necessary. The office line interface circuit 12 conducts office line interface operations to the connected office lines L. The office line interface circuit 12 transmits/receives a variety of items of control information regarding the interface operations to/from the control unit 14 via the data highway 19, the data highway interface unit 16 and the CPU bus 20.

The extension terminals 2 are connected to the extension interface circuit 13 if circumstances require. The extension interface circuit 13 performs extension interface operations for the connected extension terminals 2. Further, the extension interface circuit 13 transmits/receives a variety of items of control information regarding extension interface operations to/from the control unit 14 via the data highway 19, the data highway interface unit 16 and the CPU bus 20.

The control unit 14 integrally controls each of the time switch 11, the office line interface circuit 12 and the extension interface circuit 13 by performing processing based on an operation program stored in the storage unit 15 to realize an operation as the exchange apparatus 1.

The storage unit 15 stores the operation program of the control unit 14, a variety of pieces of data, etc., to be used durably. The storage unit 15 also stores log data (message, protocol stuck, call processing data, system management log) related to a processing history of control processing by the control unit 14. This log data includes data necessary for maintenance, such as operation history data of the extension terminals 2 and history data related to call processing.

A slot 21 is connected to the file transfer control unit 17. An outer memory 3 is detachably attached to a slot 21. The file transfer control unit 17 has a function to monitor the stored capacity of the storage unit 15 to detect whether or not a stored information quantity exceeds a set upper limit value in advance and a function to read out the log data stored in the storage unit 15 when the information quantity exceeds the set value to transfer and record it to and in the outer memory 3 though the slot 21. The outer memory 3 is a memory using a nonvolatile storage element possible to write and read at any time.

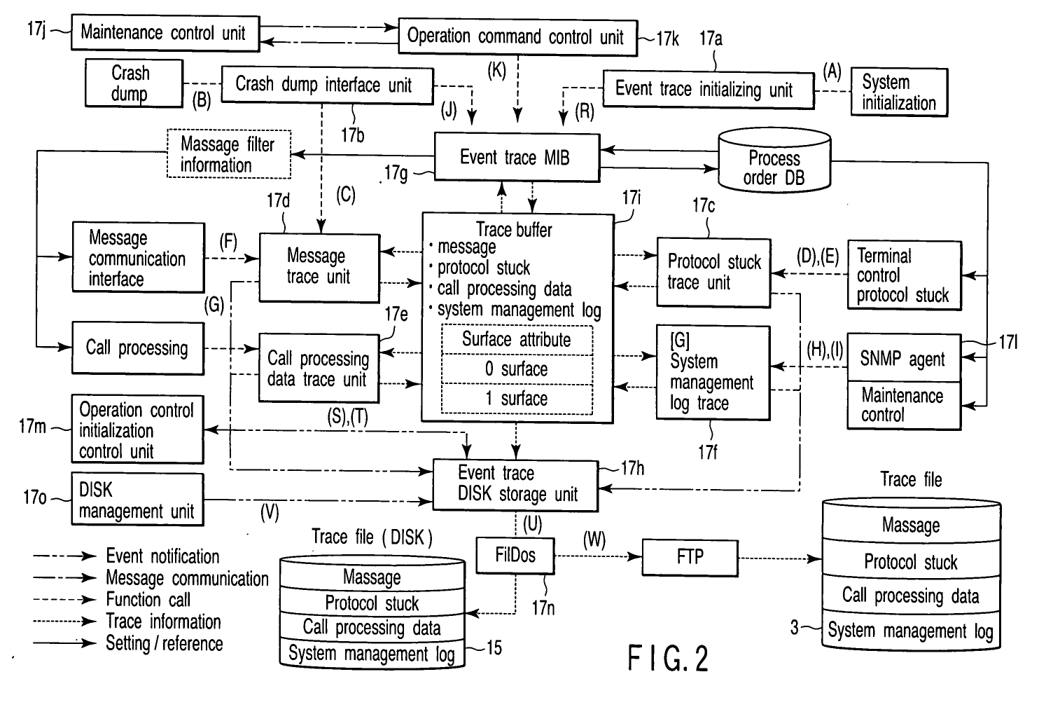

FIG. 2 is the exemplary block diagram showing the functional configuration of the forgoing file transfer control unit 17.

The file transfer control unit 17 includes an event trace initializing unit 17a, a crash dump interface unit 17b, a protocol stuck trace unit 17c, a message trace unit 17d, a call processing data trace unit 17e, a system management log trace unit 17f, an event trace MIB unit 17g, an event trace DISK storage unit 17h, a trace buffer 17i, a maintenance control unit 17j, an operation command control unit 17k, an SNMP agent 171, an operation control initialization control unit 17m and a FilDos 17n.

The event trace initializing unit 17a is activated by a function call to conduct initial setting of event trace surface attribute information and of every-task filter information of message traces.

The crash dump interface unit 17b is activated by the function call to conduct surface-switching at the time of a crash occurrence, then, (C) reads in the latest message trace data for crash dump.

The protocol stuck trace unit 17c is activated by the function call to write a content of an ISDN layer 3 message into a protocol stuck trace. A request origin determines collecting conditions (port number, message type, collecting level). (E) And the protocol stuck trance unit 17c writs setting/releasing information of L2 data link into the protocol stuck trace. The collecting conditions (port number, message type, corrective level) are determined at the request origin.

(F) The message trace unit 17d is activated by the function call though message communication processing (message reception, next priority message extracting interface) to write reception message contents into the trace buffer 17i. Collecting conditions (every-task filter) are determined at the request origin.

(G) The call processing data trace unit 17e is activated by the function call though service control to write inner data of the service control into the trace buffer 17i. The request origin determines the collecting conditions (every-task filter).

The system management log trace unit 17f is started with the function call by the SNMP agent 171 to write SNMP packet contents exchanged between an SNMP manager and the agent 171 into the trace buffer 17i. The request origin determines collecting determinations (start/stop). (I) And the log trace unit 17f writes command operation contents in a maintenance mode into maintenance operation history trace. The collecting determinations (start/stop) are determined at the request origin.

(J-R) The event trace MIB 17g is activated with the function call by the operation command control unit 17k to conduct acquiring/setting/checking of information.

(S) The event trace DISK storage unit 17h receives an initialization request message from the operation control initializing unit 17m. (T) The DISK storage unit 17h then transmits a task initializing completion notification message to the initializing control unit 17m. (U) Sequentially, the DISK storage unit 17h requires file access (writing/reading) for the storage unit 15 to the FilDos 17n. (V) And the DISK storage unit 17h receives a change notification message of DISK mounting information from the DIFK management unit 17o. (W) The DISK storage unit 17h then transfers files to any outer memory 3 at just before the file size in the storage unit 15 exceeds a specified size or with a re-starting time by system reset as an opportunity.

Next, operations in the aforementioned configuration will be explained.

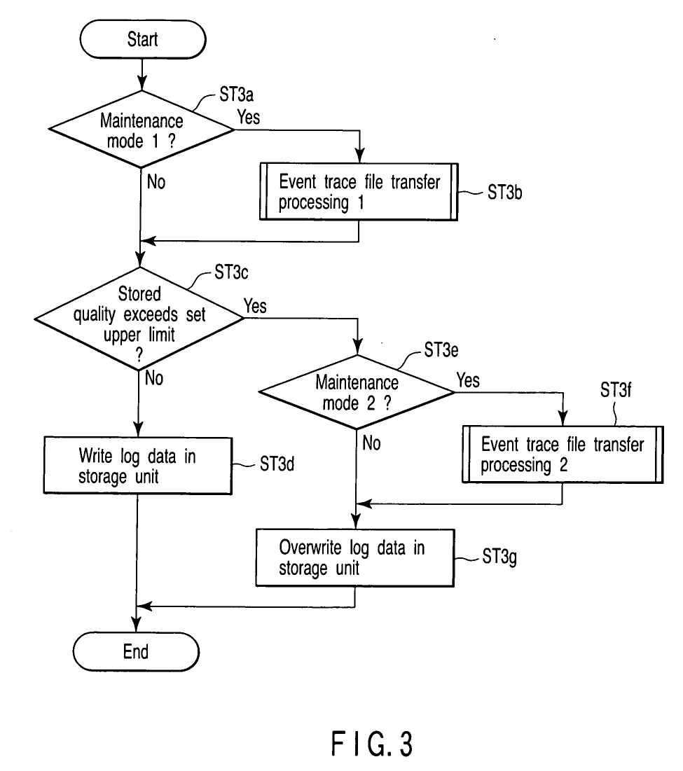

FIG. 3 is the exemplary flowchart showing the transfer control procedure of the log data by the file transfer control unit 17.

Firstly, the file transfer control unit 17 monitors whether the system reset (maintenance mode 1) is performed or not (block ST3a), reads out the log data (crash dump) stored in the storage unit 15 when the system reset is performed by an occurrence of abnormality of the exchange apparatus 1 (Yes, in block ST3a), and transfers and records it to and in the outer memory 3 (block ST3b).

Sequentially, the transfer control unit 17 determines whether or not the stored capacity of the storage unit 15 exceeds the set upper limit value (block ST3c), if it does not exceed the set upper limit value (No in block ST3c), the transfer control unit 17 records the log data in the control processing executed by the control unit 14 in the storage unit 15 (block ST3d).

On the contrary, if the stored capacity in the storage unit 15 exceeds the set upper limit value (Yes, in block ST3c), the transfer control unit 17 determines whether or not the system is set to a maintenance mode 2, that is, whether or not the system is set to a file transfer mode (block ST3e). If the system has been set to the maintenance mode 2 (Yes, in block ST3e), the transfer control unit 17 transfers and records the log data stored in the storage unit 15 to and in the outer memory 3 (block ST3f). At this moment, the transfer control unit 17 converts the data format of the log data read out from the storage unit 15 into the data format of the outer memory 3. In other word, when data formats in the storage unit 15 differs at every outer memory 3, the transfer control unit 17 can convert all pieces of the log data read out from the storage unit 15 into the data formats of every outer memory 3 by preparing a conversion table indicating the correspondences among these data formats and the data format of the storage unit 15 in the storage unit 15 in advance.

After completion of the transfer of the log date, the transfer control unit 17 records the log data in the control processing executed by the control unit 14 in an idle area in the storage unit 15 (block ST3g).

On the contrary, if the maintenance mode 2 has not been set (No, in block ST3e), the transfer control unit 17 makes a shift from the block ST3e to the block ST3g and overwrites the log data in the control processing executed by the control unit 14 onto previous log data.

If the system reset is not performed in the forgoing block ST3a, the transfer control unit 17 shifts to the processing in the above-mentioned block ST3c.

As such a manner, in the first embodiment, the slot 21 of the telephone exchange apparatus 1 mounts the outer memory 3, and the file transfer control unit 17 determines whether or not the stored capacity of the storage unit 15 to transfer and record the previous log data stored to and in the storage unit 15 if the stored capacity exceeds the set upper limit value.

Accordingly, only by mounting the outer memory 3 on the exchange apparatus 1, if the stored capacity of the storage unit 15 will be filled is possible risk, the exchange apparatus 1 can transfer to protect all previous log data stored in the storage unit 15 without manual handling.

In the first embodiment, when the system reset is performed at the time of an occurrence of abnormality of the exchange apparatus 1, even if the stored capacity of the storage unit 15 does not exceed the set upper limit value, the file transfer control unit 17 immediately transfers the log data stored in the storage unit 15 to the outer memory 3. Therefore, the telephone exchange system can prevent the log data stored in the storage unit 15 from being affected by the operational abnormality in the exchange apparatus 1.

In the first embodiment, in the case in which the stored capacity in the storage unit 15 exceeds the set upper limit value, the transfer control unit 17 determines whether or not the exchange system has been set to the maintenance mode 2 before performing the transfer processing of the log data stored in the storage unit 15. Accordingly, the user can determine whether or not it is required to transfer the log data stored in the storage unit 15 to the outer memory 3 and instruct the transfer, thereby, the user can protect only log data really needed.

In the first embodiment, further, the transfer control unit 17 converts the data format for the log data stored in the storage unit 15 into the data format for the outer memory 3 and transfers the log data to the outer memory 3. So that, the telephone exchange system can store the log data on the outer memory 3 surely, even when any type of the outer memory 3 are employed in the exchange system.

(Second Embodiment)

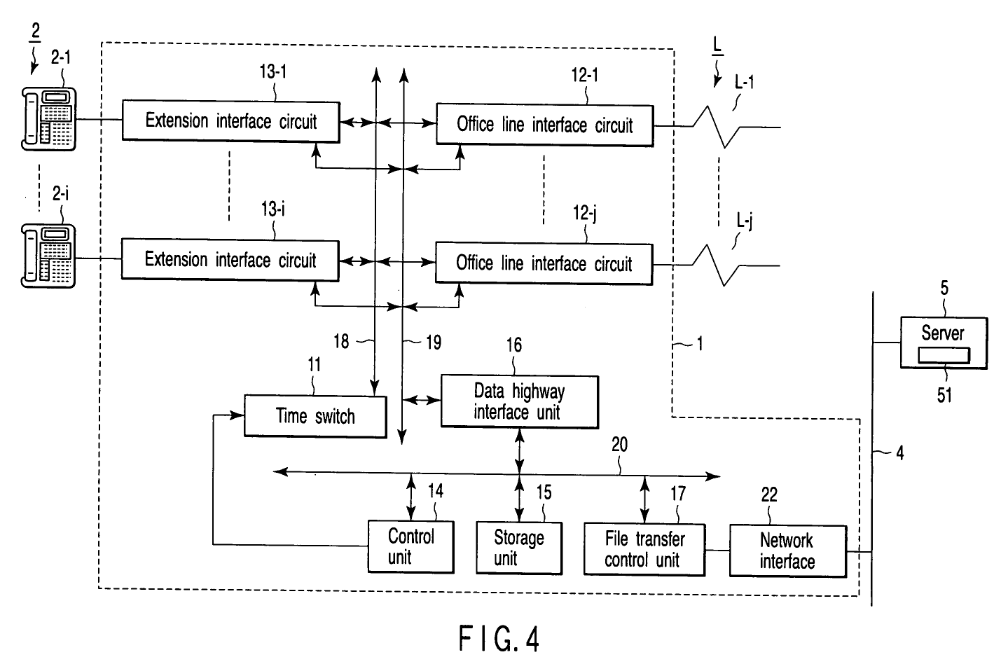

FIG. 4 is the exemplary block diagram showing the configuration of the telephone exchange system regarding the second embodiment of the present invention. In FIG. 4, the same units as those of FIG. 1 will be put the same symbols and the detailed explanation will be omitted.

In the second embodiment, a network interface unit 22, as a substitute of the foregoing slot 21, is connected to the file transfer control unit 17. A local area network (LAN) 4 is connected to the network interface unit 22 if necessary. The network interface unit 22 conducts an interface operation for the connected LAN 4.

A server 5 is connected to the LAN 4. A multi-purpose personal computer is employed as the server 5. The server 5 is provided with a storage unit 51.

When the stored information quantity in the storage unit 15 exceeds the prescribed set upper limit value, the transfer control unit 17 reads out the log data stored in the storage unit 15 to transfer it to the server 5 through the network interface unit 22 and the LAN 4. The server 5 records the log data transmitted from the exchange apparatus 1 on the storage unit 51.

Like this, even in the second embodiment, an operational effect similar to that of in the first embodiment can be obtained and the log data stored in the storage unit 15 can be protected even if the user does not mount the outer memory 3 on the exchange apparatus 1 because the log data stored in the storage unit 15 is brought into a transmission to the storage unit 51 in the server 5 via the LAN 4 if the stored information quantity in the storage unit 15 has exceeded the set upper limit value.

(Other Embodiments)

The present invention is not limited to the above-described embodiments. For instance, having described the first embodiment in which the data format of the log data is converted by the file transfer control unit 17, the external memory 3 may convert it.

Even in the second embodiment, the data format of the log data stored in the storage unit 15 may be converted in to the data format of the server 5 and the selection setting of the maintenance mode 2 can be applied.

Having explained the telephone exchange apparatus 1 as an example in each embodiment, an information processing apparatus such as a personal computer storing the log data in a hard disk, etc., may be useful. In this case, the transfer of the log data related to the communication history to the attachable outer memory 3 enables analyzing a cause, etc., of a failure and brings an extremely convenience.

For a configuration of a telephone exchange apparatus, a functional configuration of a file transfer control unit, a type of log data, a log data transfer control procedure and its content, etc., various modifications can be made and implemented without departing from the spirit or scope of the inventive concept of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus processing communication information, comprising:
a recorder which records processing record information in relation to a processing history of the communication information on a first recording medium;
a connector which connects a second recording medium differing from the first recording medium;
a detector which detects the fact that a recorded information quantity in the first recording medium has reached a reference value; and
a controller which transfers and records the processing record information in the first recording medium to and on the second recording medium, when the fact that the recorded information quantity in the first recording medium has reached the reference value.

2. A telephone exchange apparatus executing exchange processing among a plurality of telephone terminals, comprising:
a recorder which records processing record information in relation to a processing history of the communication information on a first recording medium;
a connector which connects a second recording medium differing from the first recording medium;
a detector which detects the fact that a recorded information quantity in the first recording medium has reached a reference value; and
a controller which transfers and records the processing record information in the first recording medium to and on the second recording medium, when the fact that the recorded information quantity in the first recording medium has reached the reference value.

3. The telephone exchange apparatus according to claim 2, wherein the connector includes a mounting fixture by which the second recording medium is detachably attached, when the second recording medium is a portable recording medium.

4. The telephone exchange apparatus according to claim 2, wherein the connector connects a communication network with the second recording medium connected thereto.

5. The telephone exchange apparatus according to claim 2, wherein the controller comprises:
a first processing mode which transfers and records the processing record information in the first recording medium to and on the second recording medium when it is detected that the recorded information quantity reached the reference value;
a second processing mode which overwrites the processing record information onto the first recording medium even when it is detected that the recorded information quantity reached the reference value; and
a selection controller which selectively executes the first and the second processing modes in response to a specification operation input.

6. The telephone exchange apparatus according to claim 2, wherein the controller transfers and records the processing record information in the first recording medium to and on the second recording medium when a system reset is performed.

7. The telephone exchange apparatus according to claim 2, wherein the controller includes a converter which converts the processing record information in the first recording medium into a file format of record information in the second recording medium when transferring the processing record information in the first recording medium to the second recording medium.
